(19) United States
(12) Patent Application Publication
(10) Pub. No.: US 2011/0288458 A1
(43) Pub. Date: Nov. 24, 2011

(54) AMBULATORY NEGATIVE PRESSURE THERAPEUTICAL COMPRESSION DEVICE

(75) Inventors: James W. Jones, Longmont, CO (US); Jeffrey L. Jensen, Evergreen, CO (US); Thomas E. Gage, Longmont, CO (US); John V. Atanasoff, Boulder, CO (US)

(73) Assignee: MEDEFFICIENCY, INC., Wheat Ridge, CO (US)

(21) Appl. No.: 13/088,101

(22) Filed: Apr. 15, 2011

Related U.S. Application Data
(60) Provisional application No. 61/325,179, filed on Apr. 16, 2010.

(51) Int. Cl. A61H 7/00

(52) U.S. Cl. 601/149

(57) ABSTRACT

Embodiments of the present invention relate to medical devices and treatments for chronic venous insufficiency, open ulceration and related medical conditions, and more particularly to a device and treatment incorporating negative pressure compression to the foot and lower leg or other appendage of a patient.

### CROSS-REFERENCE TO RELATED APPLICATIONS

This application claims the priority benefit of U.S. Provisional Application No. 61/325,179, entitled AMBULATORY NEGATIVE PRESSURE THERAPEUTICAL COMPRESSION DEVICE and filed on Apr. 16, 2010, which is incorporated herein by reference in its entirety.

### STATEMENT REGARDING FEDERALLY-SPONSORED RESEARCH OR DEVELOPMENT

Embodiments of the present invention were made with U.S. Government support, and the U.S. Government may have certain rights in the invention. The U.S. Government's rights in the invention are provided for by the terms of contract numbers 9R44AG026244-02 and 5R44AG026244-03, sponsored by the National Institute of Health.

### TECHNICAL FIELD

Embodiments of the present invention relate to medical devices and treatments for venous hypertension, valvular incompetence, leg swelling and open ulceration.

### BACKGROUND

Chronic venous insufficiency (CVI) is a significant and growing medical problem. The pathophysicologic basis of CVI is venous hypertension in the lower extremities. The calf muscle pump works by contracting around veins in order to force blood in the veins into motion. One-way valves within the deep venous system allow blood to flow only proximally out of the legs. Failure of these valves leads to increased venous hypertension in the superficial system, thereby decreasing calf-muscle pump efficiency. Increasing venous distension can promote increasing valvular incompetence, leading to symptoms such as leg swelling and aching, discoloring of the skin, activity intolerance, and finally open ulceration.

Increased venous pressure results in extravasation of fluid, serum proteins, blood cells into the subcutaneous tissue, eventually leading to pigmentation changes and ulceration. The high prevalence and resulting costs of venous pathology, such as health care costs, missed work, and reduced quality of life constitute a heavy burden on society. Approximately 5 million Americans exhibit some evidence of CVI and, depending on estimates, between 500,000 and 600,000 individuals has or will develop venous leg ulcers, causing recurrent hospitalization, high health care costs, and disability. Others estimate that the number of individuals that develop venous leg ulcers may be as high as one million. Fifty percent of venous ulcers may be present for 7-9 months. Between 8 and 34% of the ulcers may be present for more than 5 years, and 67%-75% of patients have recurring problems. An estimated two million work days are lost each year in the United States. The medical costs of treatment and indirect costs associated with disease can be significant.

### SUMMARY

Embodiments of the present invention provide therapy and prevention for chronic venous insufficiency, edema, chronic wounds, deep vein thrombosis, varicose veins and/or other medical problems originating from poor venous circulation by assisting the return of interstitial fluid from the limbs to the heart and lungs thereby adding nutrients and oxygen to the blood. This refreshed fluid is carried by the circulatory system to the limbs and heals unhealthy cells.

According to embodiments of the present invention, a vacuum is applied through air channels or tubes to a single or multiple chambers in a fabricated flexible sock using an electro-mechanical pump. The fabricated flexible sock is worn on any limb and includes any flexible, fluid impermeable material. An outside of the sock material is exposed to the atmosphere and the inside of the material is exposed to the skin, according to embodiments of the present invention. Single or multiple bands and/or seals are applied to the outside and/or inside of the flexible fluid impermeable material, and the bands and/or seals apply circumferential pressure to provide one or multiple vacuum tight chambers, according to embodiments of the present invention. Control of the application of the vacuum is accomplished by one or multiple check valves in series, with vacuum taps between the valves that allow the electro-mechanical pump to provide various pressures, which may include single or multiple gradient pressures, according to embodiments of the present invention.

In an alternative embodiment, application and control of the vacuum is accomplished by the use of one or more electro-magnetic pneumatic valves connected to a vacuum source by way of one or more pneumatic channels. The pneumatic valves are connected electrically to a programmable logic controller or other electronic or mechanical control device that is capable of providing constant or intermittent flow and/or singular or sequential flow for controlled vacuum time durations for a chamber or multiple chambers at constant values of vacuum.

A device for providing compressive forces in contiguous chamber locations on a patient's lower leg may include:
an elastic flexible air impermeable material formed in the shape of a sock with multiple chambers that form an air tight seal on the lower leg of the body;
seals are incorporated in the sock that provide separate air tight chambers; and/or
an electro-mechanical controlled vacuum source that is pneumatically coupled to multiple chambers in the sock.

Various embodiments on the invention may also employ one or more of the following configurations: the disposable elastic flexible material covers the limb; the material is air impermeable; the chambers form an air tight seal from one another and from the atmosphere while worn on the limb; the air tight seals are disks of thin elastic material wherein the outside diameter of the disks are the size of the inside diameter of the sock; the disk has a hole at its center of a diameter that interfaces with the limb when worn on the limb and the circumference of the disks are bonded to the inside of the sock; the air tight seals are bands of elastic material that are circumferentially located on the outside of the sock and held in place by an elastic material pocket bonded circumferentially to the sock or band loops made of elastic material to hold the bands in place; flexible tubing, air channels or direct mating with the controller providing fluid communication between the vacuum source and the one or more chambers in the sock; and/or the controlled vacuum source is directly mated with the sock and held in place with a strap, belt, or loop and hook band, or located on the thigh by way of a belt, strap or loop and hook band or located at the waist with belt clip, strap or loop and hook band; the power source is mated with the sock and held in place with a strap, belt, or loop and hook band, or located on the thigh by way of a belt, strap or loop and hook band or located at the waist with belt clip, strap or loop and hook band.

Other configurations that may be employed in various embodiments include: the power source and controlled vacuum source are separate and connected by a flexible electrical power cord; the sock, controlled vacuum source and power source are separate components allowing for disposal or reuse of the individual components; the sock, controlled vacuum source and power source are a single component; the sock is configured to cover a patient's limb with an open end allowing for insertion of a limb and a closed end portion; three seals, the first seal placed at the opening of the sock, the second seal placed mid-way between the first and third seal and the third seal placed at the ankle or wrist; the controlled vacuum source is in fluid communication with all chambers; the sock is one of a plurality of socks of multiple sizes with corresponding multiple sizes of sealing disks within, with holes at the centers of the disks, to provide a fit that seals but does not restrict blood flow for thin-walled superficial veins; the sock is one of a plurality of socks of multiple sizes with corresponding multiple sizes of elastic bands outside of the garment to provide a fit that seals but does not restrict blood flow for thin-walled superficial veins for a majority of patients; the sock opening includes a diameter to allow easy fit over the heel to ankle circumference when the leg to foot angle is 120 degrees or greater for a majority of patients; and/or the air channels, if used instead of flexible tubing, are constructed by creating an air space by ultrasonically welding elastic air impermeable flexible material to the surface of the sock in a pattern that allows three separate channels that have vents from the chamber to the air channel and from the air channel to ports on the sock that connect to the controlled vacuum source.

Furthermore, in some embodiments, each channel may have contained therein a spring, spiral wrap, or tube to prevent collapse of the air channel when sub-atmospheric pressure is induced.

In another embodiment, the controller produces constant and consistent multiple sub-atmospheric pressures to multiple chambers in the garment, and has one or more of the following features or characteristics:
said controller has multiple ball or magnetic check valves arranged in series;
a vacuum source pulls air through the valves which are closed until the pressure exceeds the release pressure rating of the valve;
all ball or magnetic check valves in the series are rated at the same pressure release value and the gradient pressure drop between the valves is the same as the value of the valve;
the valve value is chosen based on the target gradient pressure;
the absolute pressure drop between the valves is dependent on air flow and the adjusted sub-atmospheric pressure at the vacuum source;
a vacuum tap is provided between each valve which has a fluid connection to a chamber in the sock;
the sock includes one or more, for example three, different chambers with each of the three chambers having a different compression value than the other, with, for example, the highest compression at the ankle, medium compression at the mid-calf and lowest compression at the upper-calf;
all pressures can be lowered by adjusting the pin valve thereby leaking atmospheric pressure into the vacuum line which will lower the compression in all chambers and lower the gradient pressures in between chambers;
the voltage from a rechargeable power source is made constant over the discharge cycle by way of a step up/step down switching DC-DC converter which maintains pump speed regardless of battery voltage over time; and/or
all chambers of the sock keep constant and consistent compression over a day's use.

In some embodiments of the present invention, the controller provides constant compression to multiple sock chambers as a sequentially applied step function with programmable durations, and may include one or more of the following features or characteristics:
the controller includes a re-chargeable battery, step up/step down switching DC-DC converter, micro-controller, rotary or reciprocating pump, pneumatic miniature solenoid valves and pin valve;
the micro-controller or micro-programmable controller manages the operation of the normally closed electrical pneumatic switches that are in fluid communication with the chambers in the sock by opening and closing the valves on predetermined time durations and chamber location cycles;
the vacuum pump runs at a constant revolution per minute rate that is controlled by the adjustable output voltage of the Step-up/Step-down switching DC-DC converter providing a constant singular sub-atmospheric pressure at the pump; the pressure in the chambers of the sock can be set manually by adjusting the pin valve to a desired value;
the pump side of the electrical pneumatic switch array is ported to the pump and the sock chamber side of the electrical pneumatic switch array ports directly to the sock male ports or through tubing for remote mounting of the controller on the thigh or waist;
a removable battery charger is provided to recharge the battery pack after a day's use;
the controller provides a dynamic sequential controlled “milking” device. In the first period, only the ankle chamber has an applied singular vacuum, which may be, for example, a 5 second duration, in the second period, both the ankle and mid-calf chambers have vacuum which may have a duration of 5 seconds and in the third period the ankle, mid-calf and upper-calf have vacuum, which may have a duration of 5 seconds, in the fourth period, which may, for example, be 20 seconds long, all chambers are returned to atmospheric pressure and the blood in the leg or extremity is allowed to refill with fresh blood to revitalize the tissue. At the end of the fourth period the same cycle is repeated.

While multiple embodiments are disclosed, still other embodiments of the present invention will become apparent to those skilled in the art from the following detailed description, which shows and describes illustrative embodiments of the invention. Accordingly, the drawings and detailed description are to be regarded as illustrative in nature and not restrictive.

### BRIEF DESCRIPTION OF THE DRAWINGS

FIG. 1 is a perspective view of an ambulatory negative pressure therapeutical compression device assembly on a human leg, according to embodiments of the present invention.

FIG. 2 is a perspective view of an arrangement of diaphragm vacuum seals, according to embodiments of the present invention.

FIG. 3 is a perspective view of an alternative arrangement of elastic band seals, according to embodiments of the present invention.

FIG. 4 is a sectional representation of a mechanism for securing one or more bands to the flexible sock taken along the line A-A of FIG. 3, according to embodiments of the present invention.

FIG. 5 is a perspective view of a flexible sock, before evacuation, on a human leg, demonstrating its looseness to allow easy application in consideration of the heel to ankle circumference and foot angle relative to the tibia, according to embodiments of the present invention.

FIG. 6 is a perspective view of the flexible sock of FIG. 5, after evacuation, on a human leg, demonstrating evacuation of air from the sock, according to embodiments of the present invention.

FIG. 7 is a perspective view of air channels that allow evacuation of the chamber or chambers of the sock; such channels may incorporate springs, tubes and/or spiral wrap, according to embodiments of the present invention.

FIG. 8 is a sectional view of a single air channel taken along line B-B of FIG. 7, illustrating a construction technique, according to embodiments of the present invention.

FIG. 9 is a perspective view of a control module illustrating a mounting technique of the controller to the flexible sock, according to embodiments of the present invention.

FIG. 10 is a schematic of a controller utilizing a ball or magnetic check valve design, according to embodiments of the present invention.

FIG. 11 illustrates a graph of vacuum pressure verses time for the ball or magnetic check valve controller of FIG. 10, according to embodiments of the present invention.

FIG. 12 is a schematic of an alternative embodiment of a controller that manages user definable timing and the application of sub-atmospheric pressure to single or multiple chambers by sequence, progression or intermittence, according to embodiments of the present invention.

FIG. 13 is a graph of illustrating sequential application of vacuum to multiple chambers over time, according to embodiments of the present invention.

FIGS. 14A-B illustrate a system for delivering drugs according to embodiments of the present invention.

FIGS. 15A-C illustrate a vacuum device and a port of a sock according to embodiments of the present invention.

FIG. 16 illustrates an ultrasonic transducer and a port of a sock according to embodiments of the present invention.

FIG. 17 illustrates a dual layer sock according to embodiments of the present invention.

FIG. 18 illustrates a sock with positive pressure seals according to embodiments of the present invention.

FIG. 19A illustrates a top view of a sock with balloon seals according to embodiments of the present invention.

FIG. 19B illustrates a sectional view taken along the line A-A of FIG. 19A.

FIG. 19C is a side view of the sock of FIG. 19A.

FIGS. 20A-B illustrate a thermal device and a port of a sock according to embodiments of the present invention.

FIGS. 21A-B illustrate a controller configured to introduce ozone or nitric oxide into a sock through a port according to embodiments of the present invention.

FIGS. 22A-C illustrate a drug delivery system and a port of a sock according to embodiments of the present invention.

FIGS. 23A-C illustrate socks employing helical pressure chambers according to embodiments of the present invention.

FIG. 24 illustrates a cross sectional view of an inner layer and an outer layer of a sock according to embodiments of the present invention.

FIG. 25 illustrates a cross sectional view of an upper portion of a sock according to embodiments of the present invention.

While the invention is amenable to various modifications and alternative forms, specific embodiments have been shown by way of example in the drawings and are described in detail below. The intention, however, is not to limit the invention to the particular embodiments described. On the contrary, the invention is intended to cover all modifications, equivalents, and alternatives falling within the scope of the invention as defined by the appended claims.

### DETAILED DESCRIPTION

While the etiology and pathophysicology of CVI and resulting venous ulcers are well established, there has not been satisfactory progress in the treatment of this problem. Compression of the foot and lower leg may be beneficial in the treatment of CVI. It is believed that the application of external pressure to the calf muscles raises the interstitial pressure, forcing blood into the deep venous system, decreasing the superficial venous pressure and improving venous return, leading to a reduction in superficial hypertension. This allows ulcers to heal. Gradient pressure may be achieved using a “Jobst® stocking”, for example, a compressive sock (related to compression bandages and hosiery) that is worn around the foot and lower leg. Compression techniques have been used in a number of different treatment regimes, achieving a reasonable degree of success when combined with good patient compliance. Unfortunately, compression has not proven efficacious in poorly compliant patients, who universally have a high rate of ulcer persistence or recurrence. Several factors contribute to poor patient compliance. Often patients do not have enough strength or mobility to pull on compression stockings. Attempts have been made to overcome these difficulties, such as by use of a zippered back (Jobst®), or leggings with a series of interlocking bands fastened with hoop and loop fasteners (CircAid®). However, even these improvements have not been successful in solving the problem of poor compliance.

Such compression socks may be ineffective in patients with massive edema or obesity, as the socks lose their elasticity over time. By the end of the day, edema often returns along with the symptoms. As a result of the loss of elasticity, these socks must be replaced frequently—generally every three or four months.

Embodiments of the present invention incorporate negative pressure, dynamic gradient compression, comfort, ease of application and/or total ambulatory freedom.

Inflatable socks may be used to apply compression to the foot and lower leg in a non-ambulatory setting. Such devices often do not allow patients to be ambulatory while under therapy or for periods of time that will provide successful therapies. Sequential inflatable compression devices are used to “milk” fluid in the legs proximally. These devices can be bulky and interfere with normal gait and/or ambulation. These inflatable devices sometimes include multiple compressed air bladders with intermittent “dead spaces” between bladders that attenuate the values of the therapy, and these bladders can be susceptible to puncture or tearing.

Embodiments of the present invention are capable of applying gradient pressure (multiple chambers with differing pressure values) and/or dynamic sequential/synchronous compression (control of each of multiple separate chamber actuation by compression, order and time) in an ambulatory patient in the treatment of CVI, wound healing and other similar or related conditions.

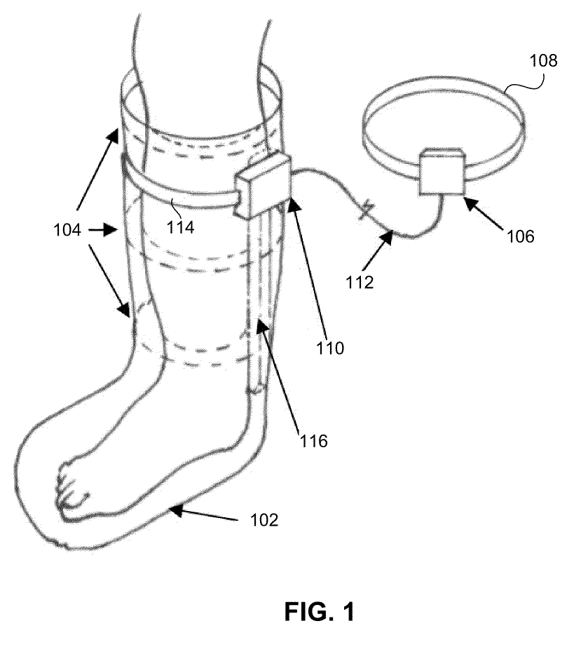

With reference to FIG. 1, a flexible garment 102 may be used in accordance with embodiments of the invention. The flexible garment 102 may be configured like a sock for use on a subject's leg or may be configured for use with other appendages. The flexible garment 102 may be formed of a flexible air impermeable material. Seals 104 are used to create an air space between the inside of the flexible garment and the subject's leg or other appendage. FIG. 1 also illustrates a mobile power source 106 that may be secured to the waist, thigh or lower leg using a band 108. The mobile power source 106 is connected to a controller 110 through a power cable 112. The controller 110 may be secured to the flexible garment 102 by a band 114, and may be configured to control pressure within the flexible garment through one or more air channels 116. The air channels 116 may include one or more valves, and the bands 108, 114 may be a belt clip, strap, elastic band, or other attachment mechanisms. The controller 110 may be mechanical or electronic in nature and may control a rotary or reciprocating pneumatic vacuum pump. Air is drawn from a chamber or chambers within the flexible garment by way of the pump, through air channels 116, to the atmosphere, creating one or more sub-atmospheric pressure conditions within the flexible garment 102.

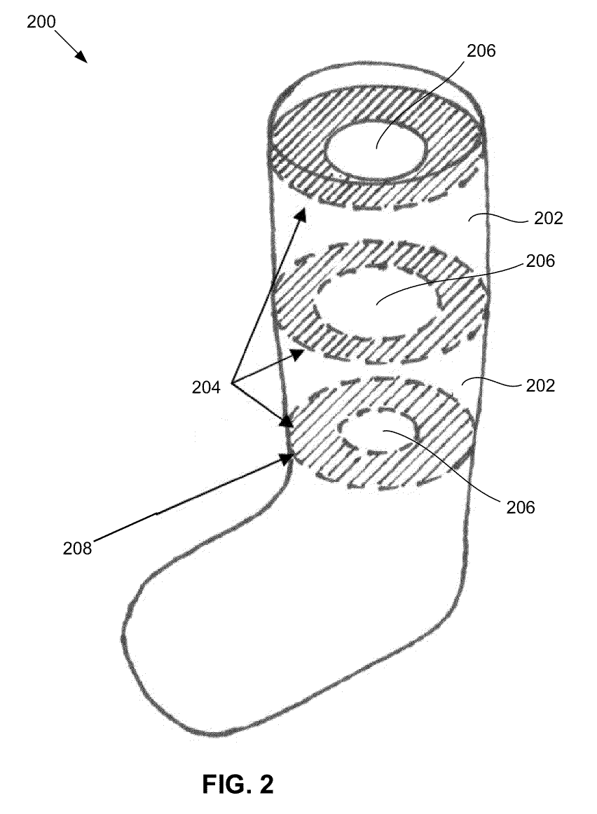

According to embodiments of the invention, a flexible air impermeable disposable sock 200 with one or multiple chambers 202, as illustrated in FIG. 2, is created by flexible air impermeable disks 204 with holes 206 at the center of a diameter to cause minor deflection of the material when applied around the leg, or other appendage, thereby applying an air tight seal. At the same time, the seals provided by the disks 204 are not tight enough to restrict the emptying of the thin-walled superficial veins. Other embodiments use socks 200 and disks 204 of varying sizes in order to create air tight seals while allowing thin-walled superficial veins to empty. In some embodiments, the disks are ultrasonically bound, or otherwise adhered to, the flexible sock material, as shown at location 208.

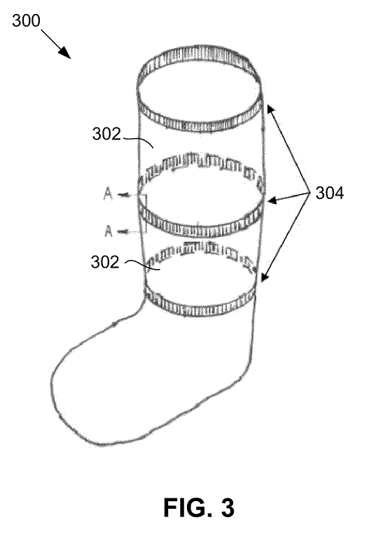

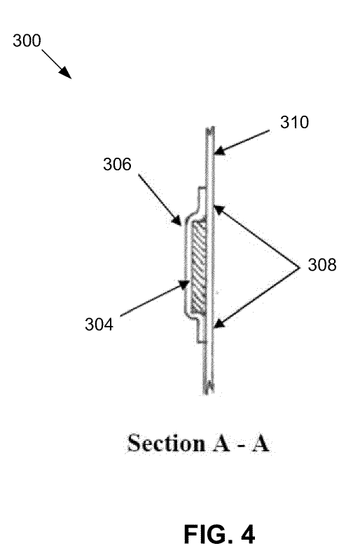

In the embodiment illustrated in FIGS. 3 and 4, a flexible air impermeable disposable sock 300 includes one or multiple chambers 302, defined by elastic bands 304 that are secured in pockets 306, as illustrated in FIG. 4. The pockets may be attached to the sock 300 by ultrasonic welding 308 or through other attachment methods. The sock 300 is configured to fit snugly when applied to a human appendage. In another embodiment, the elastic bands 304 are secured in pockets that include a window through which the elastic bands 304 may be adjusted by way of a hook and loop fabric.

In some embodiment, the sock is oversized in order to easily fit over the ankle-to-heel circumference, which for some subjects may be larger than the circumference of the calf even with the foot minimally extended (e.g., with the foot extended approximately 120 degrees).

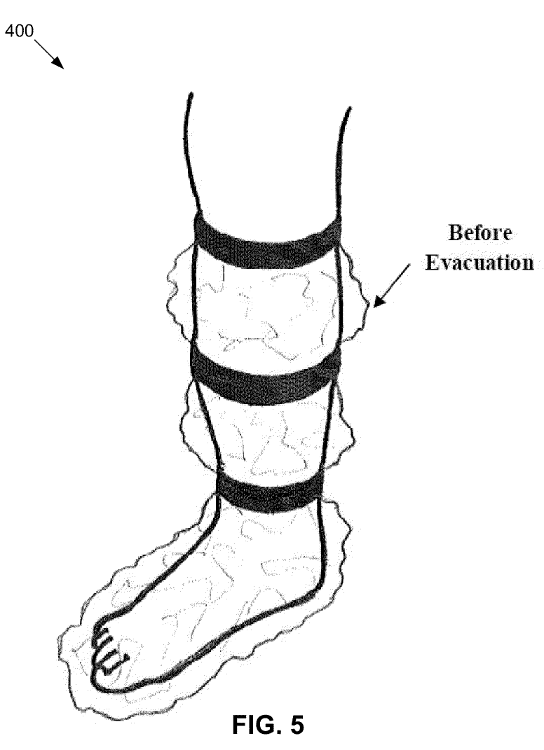

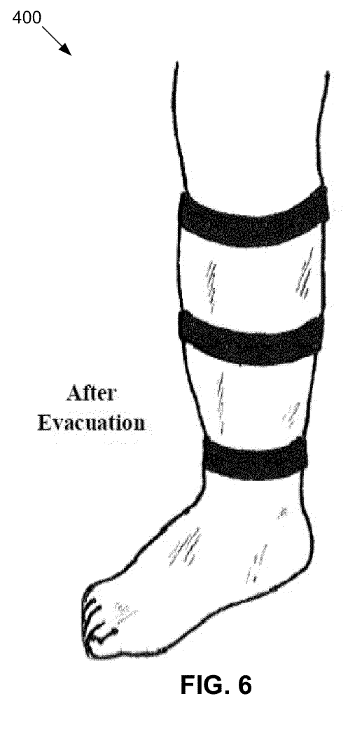

FIGS. 5 and 6 illustrate a sock 400 before and after evacuation of the air according to embodiments of the invention. Although not depicted, a sock 200 with seals 204, as illustrated in FIG. 2, may similarly be slightly oversized to fit over a patient's ankle-to-heel circumference. Ease of application and production of air tight seals is a significant problem with existing devices.

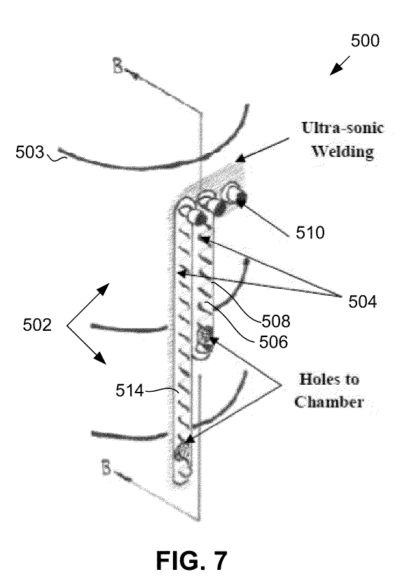

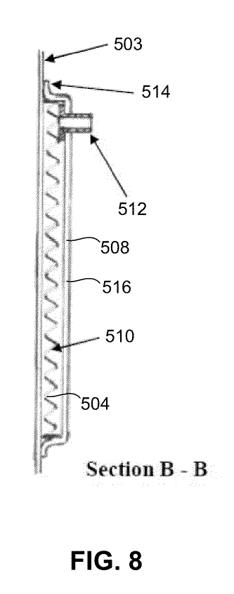

FIGS. 7 and 8 illustrate a system 500 that extracts air from the chambers 502 of a sock 503 through air channels 504 by way of a vacuum generated by an electromechanical pump, according to embodiments of the present invention. An air channel 504 may be provided or fabricated by the use of a small diameter flexible plastic tube 506 with or without an air impermeable flexible material enclosure 508. As shown in FIG. 8, the air channel 504 may be formed by a spiral wrap 510 encased in a flexible air impermeable material 508. In other embodiments, the air channel 504 may be formed by a spring encased in a flexible air impermeable material 508. Multiple air channels 504 may be ultrasonically welded 514 to the sock 503 or otherwise adhered to the sock 503 forming separate and independent air channels 504. Male chamber ports 512 may be provided on the sock to connect with the air channels 504 to form air tight seals and allow easy access to the female ports on the controller. The spiral wrap 510 or spring provide internal support to the air channel pocket 516 while under sub-atmospheric pressure to prevent collapse of the air channel 504, according to embodiments of the present invention.

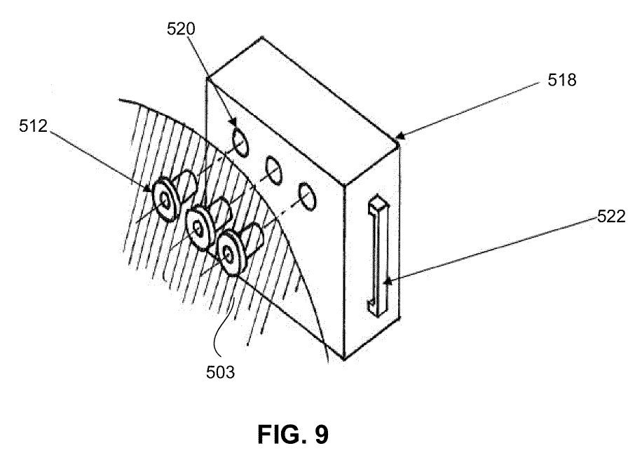

As shown in FIG. 9, a controller 518 can interface directly with the sock upon insertion of the male ports 512 on the sock 503 into the female ports 520 on the controller 518, according to embodiments of the present invention. The controller 518 may also include a belt loop 522.

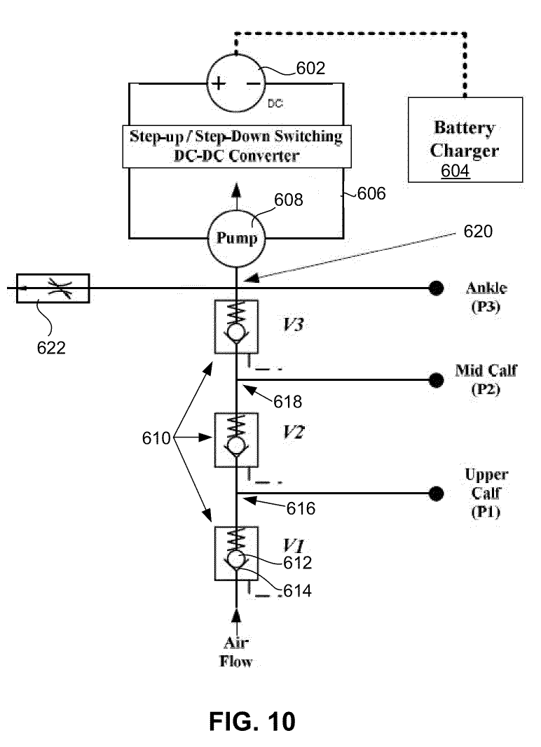

FIG. 10 illustrates an exemplary schematic of the controller 518. The controller 518 provides multiple sub-atmospheric consistent pressures simply and effectively to multiple chambers in the sock, according to embodiments of the present invention. A DC voltage from power source 602 (e.g., a battery), which is recharged from a removable battery charger 604, is synthesized by an adjustable step-up/step down switching DC-DC converter 606 to provide a constant voltage to the pump 608 (e.g. 5 Volts DC). In existing devices, the rotational speed of the pump decreases as available voltage decreases, which in turn reduces the pressure that the pump provides. Existing devices, including fabric compression devices (e.g., Jobst®, CircAid® and the like), lose compression during use. The DC to DC converter provides an adjustable constant voltage supply over the use of the device providing a constant pressure and therefore consistent therapy, according to embodiments of the present invention. This is a substantial advancement over existing technologies which do not provide constant pressure therapy, resulting in reduced efficacy and costly replacement of devices.

As air is drawn through the device illustrated in FIG. 10 it passes through multiple ball or magnetic check valves 610 that are arranged in series, according to embodiments of the present invention. Each ball or magnetic check valve 610 releases air pressure at a certain air pressure level that is determined by the amount of force a spring exerts on a ball or magnet 612 set in an internal seal 614, according to embodiments of the present invention. The ball or magnetic check valves 610 are configured based on a target gradient pressure selected by the designer. If the ball or magnetic check valves 610 have the same value, then the gradient pressure drop between valves will be the same. The absolute pressure drop between any two valves is also dependent on air flow and adjusted air pressure input. Taps 616, 618, 620 are provided between each valve (V³, V², and V¹) to produce gradient sub-atmospheric values P³, P² and P¹. The sub-atmospheric value of the pressure gradients P² and P¹ can be expressed as:
P³=Manually Adjusted Pump Pressure
V=Release Pressure of the Ball or magnetic check valve

P²=P³−V

P¹=P²−V
For example:
Required Gradient Pressure: 12 mmHg
V³, V², V/=12 mmHg
P³ is adjusted to 40 mmHg

P²=P³−V=40−12=28 mmHg

P¹=P²−V=28−12=16 mmHg

The highest vacuum is created at the junction of the pump 608, pin valve 622, and ankle tap P³ 620, according to embodiments of the present invention. The tap 620 (P³) is fluidically connected to the ankle section of the sock, according to embodiments of the present invention. The level of the vacuum at P³ may be adjusted by way of the pin valve 622 at any constant voltage. By allowing a controlled amount of leakage from atmosphere pressure, through the pin valve, into the junction between the pump and V³, the vacuum can be adjusted to any lesser value. The pressures at P² and P¹ may be determined with the formulas presented above.

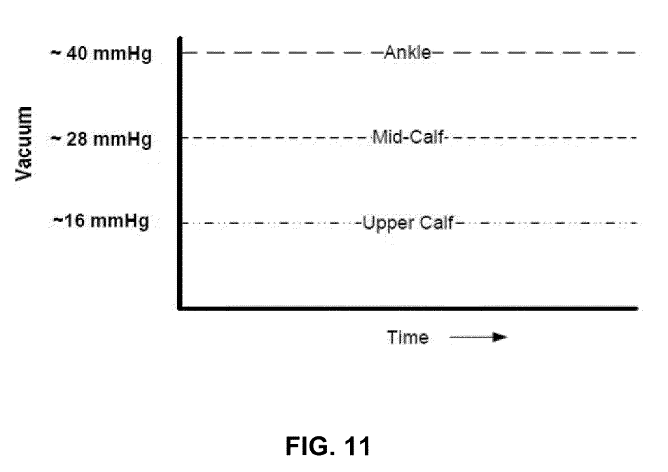

FIG. 11 illustrates a graph of pressure versus time, for the ankle, mid-calf and upper calf chambers for the controller illustrated in FIG. 10, according to embodiments of the present invention. In this example, the sub-atmospheric pressure values remain at a constant 40 mmHg, 28 mmHg and 15 mmHg regardless of the drain down of the battery. Based on the disclosure provided herein, one of ordinary skill in the art will recognize that other pressure values and/or numbers of pressure zones may be used.

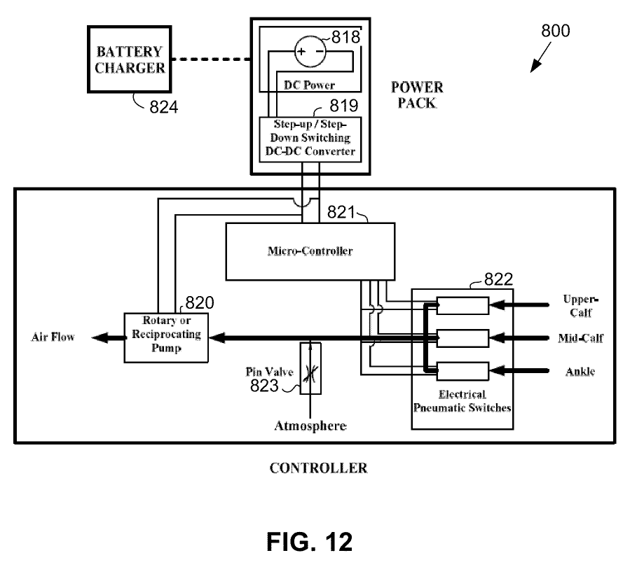

FIG. 12 illustrates a schematic of another controller 800, which employs a different approach to vacuum control and application, according to embodiments of the present invention. Vacuum may be applied as a step or progressive function, singularly or sequentially, constantly or intermittently, with programmable time periods for each chamber. A DC voltage from power source 818 (e.g. a battery) is synthesized by an adjustable step-up/step-down switching DC-DC converter 819 to provide a constant voltage to the rotary or reciprocating pump (e.g. 5 Volts DC). Without component 819, the rotational speed of the pump decreases as available voltage is reduced, which in turn reduces the pressure that the pump 820 provides. Existing devices, including fabric compression devices (e.g. Jobst®, CircAid®, and the like) lose compression during use. The DC to DC converter provides an adjustable constant voltage supply over the daily use of the device, thus providing a constant pressure and therefore consistent therapy. Existing technologies often do not provide constant pressure therapy, resulting in reduced efficacy and costly replacement.

A micro-controller or micro-programmable controller 821 manages the operation of the normally closed electrical pneumatic switches 822 to actuate on predetermined time and chamber location cycles, according to embodiments of the present invention. Pump 820 runs at a constant or substantially constant revolution per minute rate that is controlled by the adjustable output voltage of the step-up/step-down switching DC-DC converter 819 providing a substantially constant singular sub-atmospheric pressure that is set manually by the controlled voltage and by adjusting the pin valve 823 to a desired value, according to embodiments of the present invention. One side of the electrical pneumatic switch array 822 is ported to the pump, and the other side of the electrical pneumatic switch array 822 ports directly to the sock male ports or indirectly through tubing for remote mounting (e.g. mounting to a calf or waist), according to embodiments of the present invention. A removable battery charger 824 is provided to recharge the battery pack after a day's use, according to embodiments of the present invention.

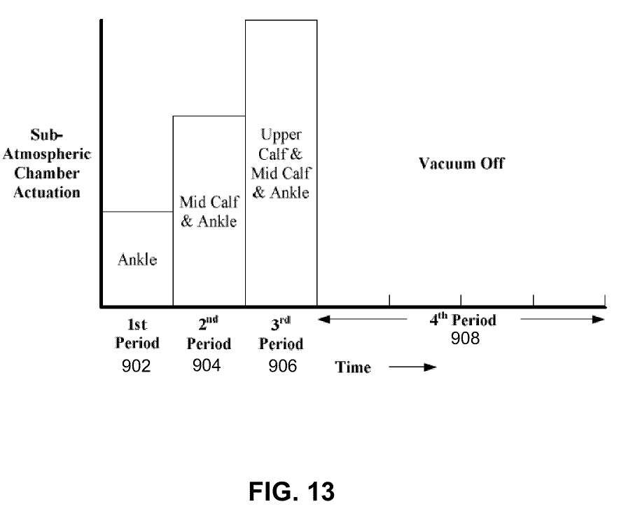

FIG. 13 illustrates a graph of a control cycle demonstrating a dynamic sequential control of a “milking” device. In the first period 902, which may be 5 seconds long for example, only the ankle chamber has an applied vacuum, for example 30 mmHg. In the second period 904, which may be 5 seconds in duration for example, both the ankle and mid-calf chambers experience vacuum, and in the third period 906 the ankle, mid-calf and upper-calf are under vacuum for a duration of, for example, five seconds. In the fourth period 908, which may, for example, be 20 seconds long, all chambers are returned to atmospheric pressure and the blood in the leg or extremity is allowed to refill with fresh blood to revitalize the tissue. At the end of the fourth period 908 the same cycle begins, according to embodiments of the present invention.

In an alternative cycle, during the first period, which may be 5 seconds long for example, only the ankle chamber has an applied vacuum, for example 30 mmHg. In the second period, which may be 5 seconds in duration for example, only the mid-calf chambers experiences vacuum. In the third period, only the upper-calf is placed under vacuum for a duration of, for example, five seconds. In the fourth period, which may, for example, be 20 seconds long, all chambers are placed at atmospheric pressure and the blood in the leg or extremity is allowed to refill with fresh blood to revitalize the tissue. In other embodiments, the fourth period may be omitted and the cycle may begin again.

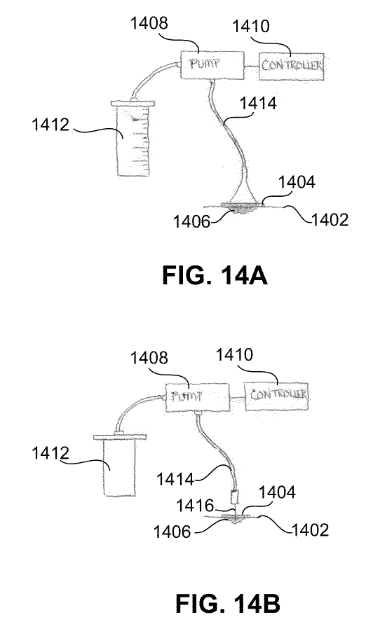

FIGS. 14A-B illustrate a sock 1402 having a port 1404. In some embodiments, the port 1404 comprises a patch that is placed over a hole formed in the sock 1402. In other embodiments, the sock 1402 includes a port 1404 for each chamber. The ports 1404 may have a seal that enables the chambers to maintain their pressure level. In addition, the ports and seals may be configured to permit various devices, for example tubes, needles, catheters, and/or electro-magnetic devices, to access the interior of the sock 1402 while maintaining the pressure level within the chambers.

In some embodiments, the port 1404 is a universal port configured to receive a variety of devices, such as the devices shown in FIGS. 14A-B, and may be placed over a wound 1406. One device that may be used with the port 1404 is a pump 1408. The pump 1408 is operated by a control 1410, and accesses a reservoir 1412 that includes, for example, medicine. The pump 1408 is attached to a tubing 1414 that couples with the port 1404. The pump 1408 may send medicine from the reservoir 1412 through the tubing 1414 and the port 1404 to the wound 1406. In other embodiments, the tubing 1414 includes a catheter 1416 configured to deliver medicine through the port 1404 to the wound 1406.

In some embodiments, the port 1404 is not placed directly over the wound 1406 but is instead placed on the chamber in which the wound is located. In such cases, the port 1404 permits connection of the tubing 1414 to the sock 1402 at a standard location, such that the port 1404 is located on each chamber without regard to the location of the wound. Separate tubing (not shown) may be connected to the other end (e.g. the inside) of the port 1404 on the inside of the sock 1402, and then extended between the port 1404 and the actual wound location, and may be coupled with or placed adjacent to the wound and/or the wound dressing on the inside of the sock 1402. In this manner, the ports 1404 may be located on the sock 1402 based on convenience of external attachment (e.g. aligned on the same side of the sock), and then during the application of each particular sock 1402, internal tubing may be employed to extend the suction, medicine delivery, ozone delivery and/or other wound treatment or therapy delivery systems from the location of the port 1402 to the location of the wound.

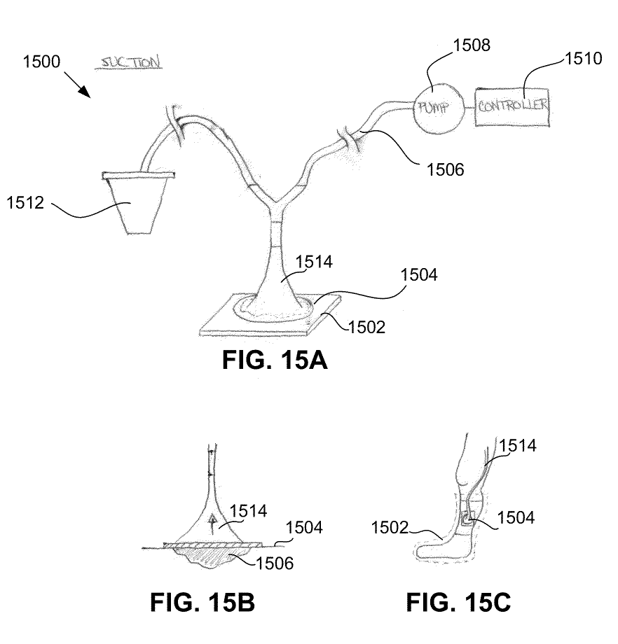

As shown in FIGS. 15A-C, a vacuum device 1500 configured to couple to a sock 1502 having a port 1504, such as a universal port, according to embodiments of the present invention. The port 1504 may be located on the sock 1502 so as to be over a wound 1506. The vacuum device 1500 may include a pump 1508, a controller 1510, a reservoir 1512, and a tubing 1514. The tubing 1514 may be configured to couple with and form an air-tight seal with the port 1504. The pump 1508 is activated by the controller 1510 and creates a vacuum in the tubing 1514, which pulls matter from the wound 1506 inside the sock 1502 up through the tubing 1514 and into the reservoir 1512. Such a configuration could be useful, for example, in draining the wound 1506 without removing the sock 1502.

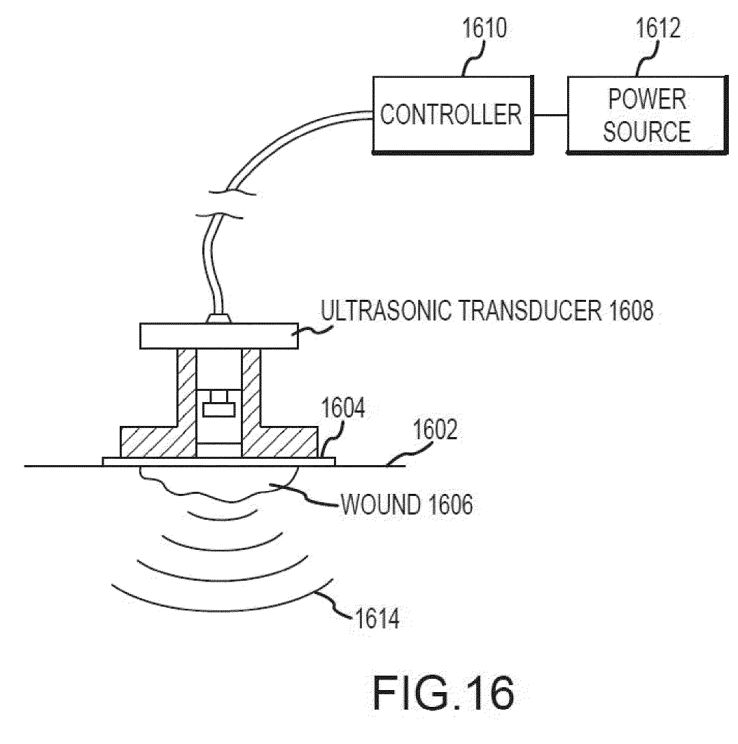

FIG. 16 illustrates a sock 1602 having a port 1604, which may be a universal port, placed over a wound 1606. In some embodiments, an ultrasonic transducer 1608, operated by a controller 1610 and powered by a power source 1612, may be placed over the port 1604. In other embodiments, the ultrasonic transducer 1608 couples with the port 1604 for direct access to the wound 1606. When activated, the ultrasonic transducer 1608 may send energy 1614 into and/or through a wound 1606 to promote healing, for example.

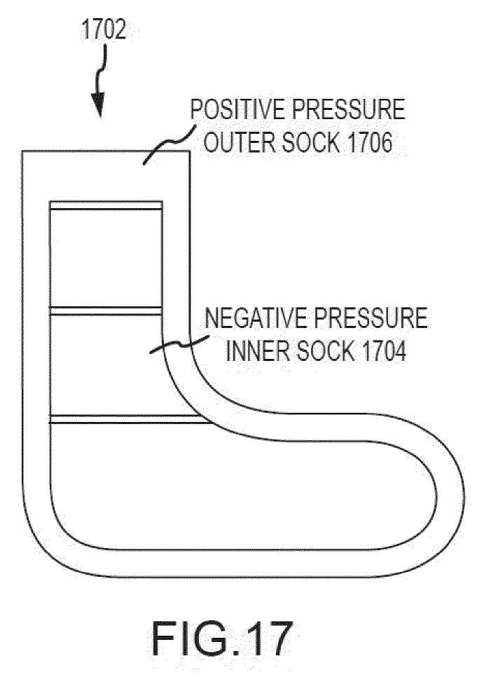

FIG. 17 illustrates a dual layer sock 1702 that includes an inner sock 1704 and an outer sock 1706. In some embodiments, a negative pressure is applied to the inner sock 1704 and a positive pressure is applied to the outer sock 1706. In other embodiments, the negative pressure is applied to the outer sock 1706 and the positive pressure is applied to the inner sock 1704.

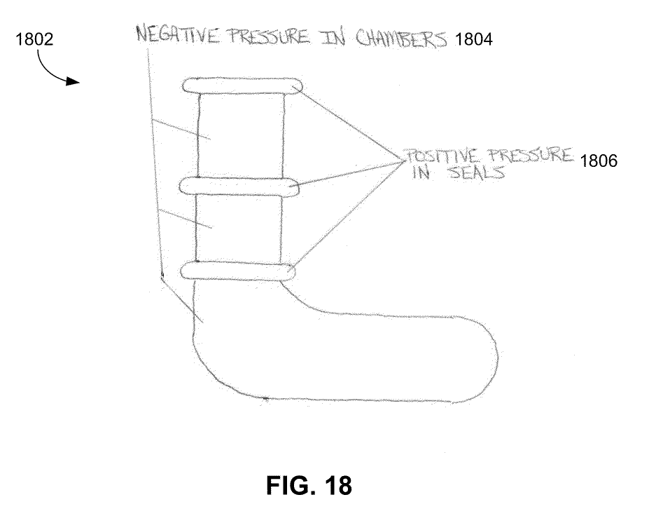

As shown in FIG. 18, a sock 1802 includes one or more chambers 1804 in which negative pressure is applied, according to embodiments of the present invention. The sock 1802 also includes one or more seals 1806 in which positive pressure is applied. In other embodiments, the chambers 1804 receive a positive pressure and the seals 1806 receive a negative pressure. The seals 1806 may themselves be independent chambers, which may be supplied with positive pressure in order to seal around the subject's limb and hinder or prevent fluid flow between the various chambers formed by the sock 1802 and the patient's limb, according to embodiments of the present invention.

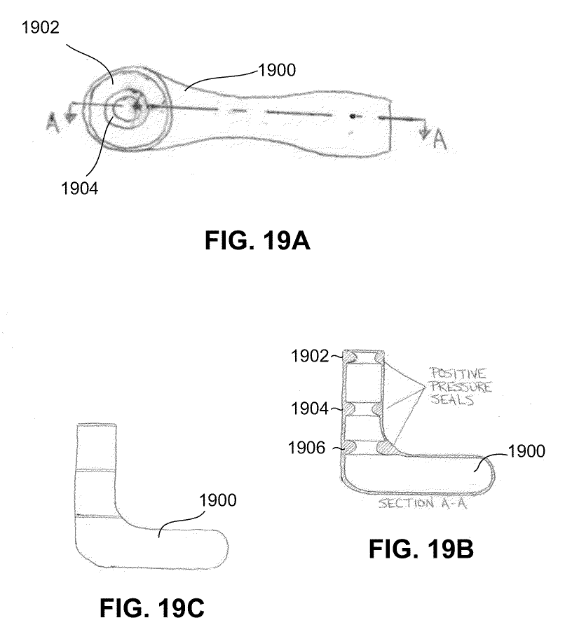

FIGS. 19A-C illustrate a sock 1900 according to various embodiments of the present invention. The sock 1900 includes a plurality of positive pressure seals 1902, 1904, 1906. The pressure seals 1902, 1904, 1906 may be of varying sizes to match the varying diameters of a patient's lower leg. In some embodiments, the pressure seals 1902, 1904, 1906 may operate independent of each other, applying positive pressure to distinct parts of a patient's lower leg in many different patterns. For example, the pressure seals 1902, 1904, 1906 may inflate sequentially. A negative pressure may be applied within the sock 1900 and/or within the chambers formed while the positive pressure seals 1902, 1904, and 1906 (which may themselves be independent chambers) are activated, according to embodiments of the present invention.

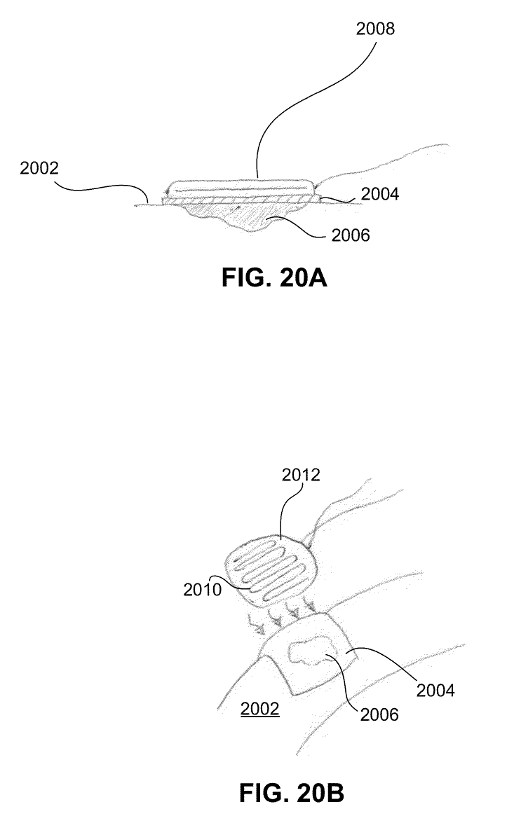

FIGS. 20A-B illustrate a sock 2002 having a port 2004, which may be a universal port, placed over a wound 2006. In some embodiments, a thermal device 2008 is placed over the port 2004, while in other embodiment the thermal device 2008 couples with the port 2004 to directly access the wound 2006. In some embodiments, the thermal device 2008 includes heating coils 2010 placed on a lower surface 2012 of the thermal device 2008. When activated, the thermal device 2008 transmits energy to the wound 2006 to promote healing, for example.

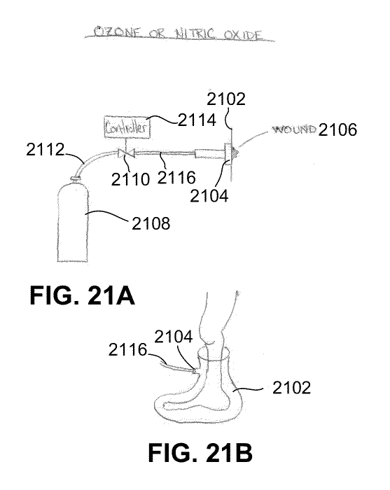

FIGS. 21A-B illustrate a sock 2102 incorporating a port 2104, for example a universal port, through which a gas may be introduced into the sock 2102. In some embodiments, the port 2104 is placed over a wound 2106. A gas source 2108 may be coupled to a control valve 2110 by a first tubing 2112. The control valve 2110 may be operated by a controller 2114, and may be coupled to the port 2104 by a second tubing 2116. The controller 2110 may selectively introduce a gas from the gas source 2108 into the sock 2102, for application onto the wound 2106, for example. In other embodiments, the controller 2114 may introduce enough gas to inflate the sock 2102, as shown in FIG. 21B. In some embodiments, the gas may be ozone or nitric oxide.

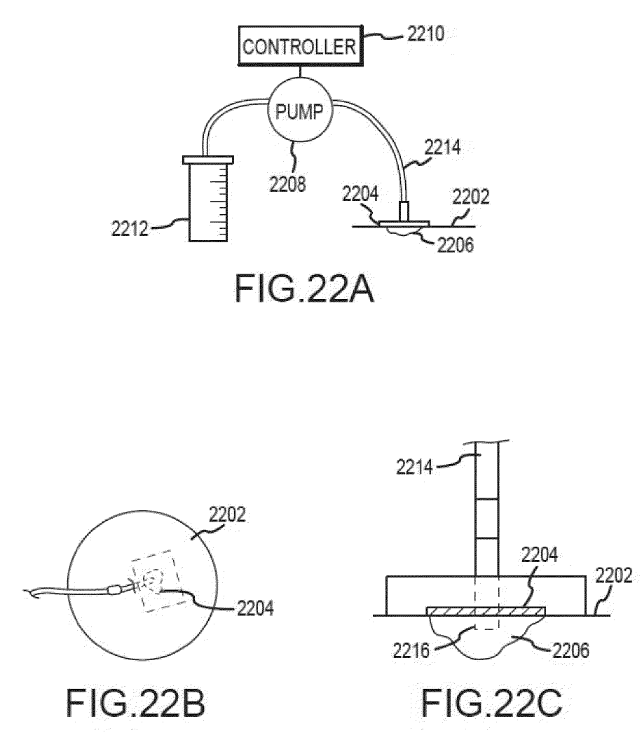

In other embodiments, for example those shown in FIGS. 22A-C, a sock 2202 includes a port 2204 placed over a wound 2206. In some embodiments, a pump 2208 is operated by a controller 2210 to deliver medicine and/or other fluids from reservoir 2212 through a tubing 2214 to the wound 2206. As shown in FIG. 22C, the tubing 2214 may include a catheter 2216 to deliver the medicine to the wound 2206. In some embodiments the catheter 2216 may pierce the port 2204.

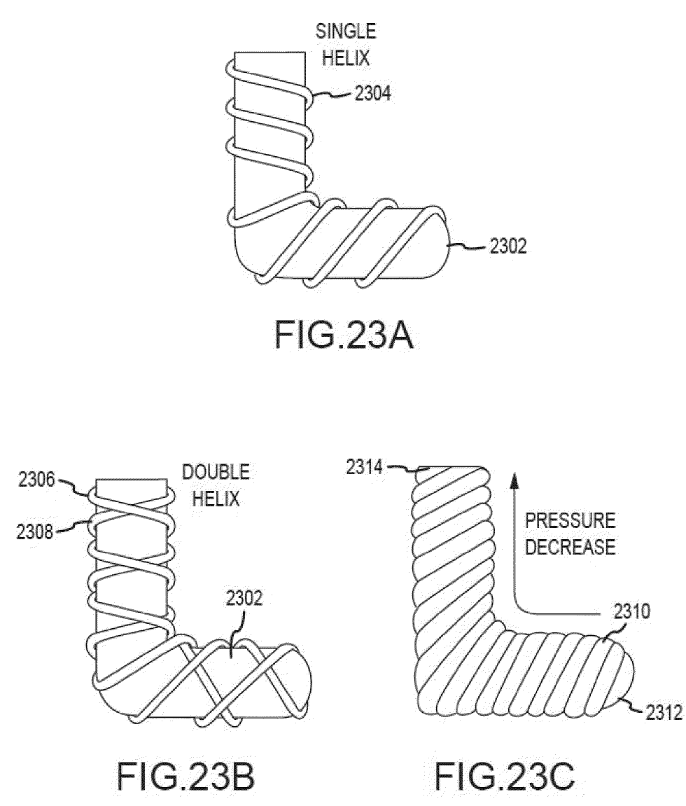

In yet other embodiments, for example those shown in FIGS. 23A-C, a sock 2302 may incorporate a pressure chamber 2304 configured as a single helix wrapped substantially around the sock 2302. In other embodiments, the sock 2302 may incorporate two pressure chambers 2306, 2308 configured in a double helix wrapped around the sock 2302. Alternatively, one or more pressure chambers 2310 may wrap around the sock 2302 and cover substantially the entire sock 2302. The pressure within the chambers 2310 may be configured to exert decreasing pressure on the sock from a toe portion 2312 to a top portion 2314. In other embodiments, the pressure chambers may be configured to exert negative pressure on select portions of the sock. In particular, the selected portions of the sock may be chosen in a linear fashion, starting from a toe portion 2312 of the sock 2302 to a top portion 2314 of the sock 2302. The pressure chambers 2304, 2306, 2308, 2310 may be inflated with positive pressure gas and applied by themselves over a patients limb, and/or may be applied over a negative pressure sock, according to embodiments of the present invention.

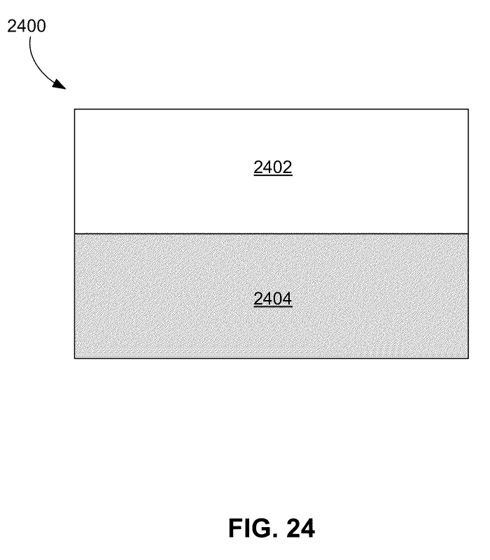

Referring to FIG. 24, according to some embodiments, a sock 2400 may include an outer layer 2402 and an inner layer 2404. The outer layer may be a flexible, air impermeable layer, and the inner layer 2404 may be configured for user comfort and may be formed of a foam, for example. Alternatively, the inner layer 2404 may be formed from a thin strip of a cotton-based material that is wrapped around the patient's limb, or a cotton inner sock, according to embodiments of the present invention. Inner layer 2404 may be referred to as a “comfort” or low compression layer. Inner layer 2404 may be a separate sock applied prior to application of the negative pressure sock 2402; alternatively, inner layer 2404 may be incorporated with outer layer 2402 to form a dual-layer sock. Although two layers are discussed, the sock 2400 may also include one or more additional layers, for example extra “comfort” layers below the outer layer 2402. Sock 2400 may alternatively include an inner flexible air-impermeable layer, a “comfort” middle layer 2404, and an outer flexible air-impermeable layer 2402, to form one or more closed cavities within the sock 2400, such that the sock 2400 does not rely on the patient's limb, or an undersock applied to the patient's limb, to form a portion of each pressure zone chamber, according to embodiments of the present invention.

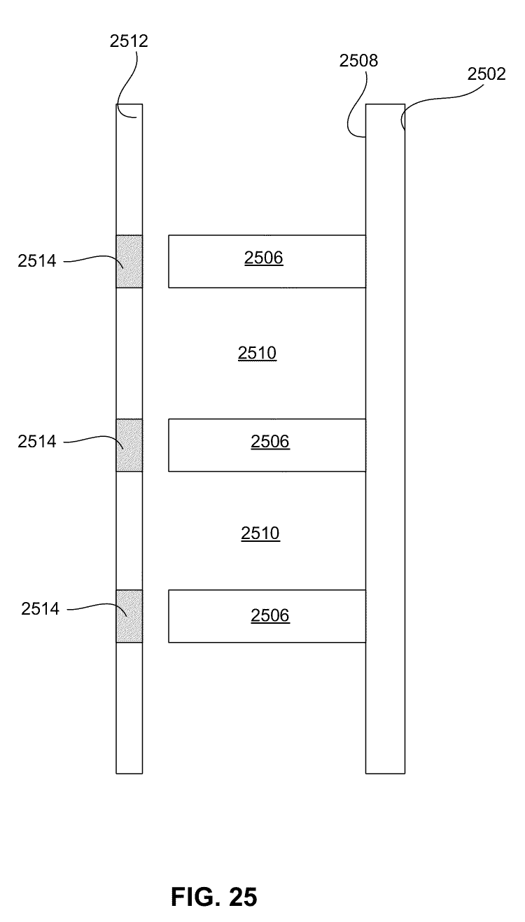

Referring to FIG. 25, in some embodiments, an outer layer 2502 is formed of a flexible, air impermeable material with one or more disks 2506 attached to the inside surface 2508 of the outer layer 2502. The disks 2506 may be configured to create air tight chambers 2510 between the outer layer 2502 and the patient's limb. In situations in which an under-sock, or “comfort” layer, is worn on the patient's limb below the negative pressure sock, such under-layers may interfere with the proper seal between the pressure zones which would normally be created by the contact of the disks 2506 with the patient's skin. For example, a cotton sock worn under the negative pressure sock might permit air to flow around the disks 2506 by flowing through the air permeable structure of the cotton sock. To complete the air tight chambers, an inner layer 2512 may incorporate bands 2514 of air impermeable material that are or may be aligned with the disks 2506. In that arrangement, the disks 2506 of the outer layer 2502 are configured to connect with, press against, and/or otherwise contact the bands 2510 of the inner layer 2512 to create an impermeable seal between chambers.

A “universal port” as discussed herein is a port which accepts the hardware connections for two or more different wound treatment and/or therapy systems on the same sock. For example, the same port formed on the sock may be used to interface with and/or fluidly couple with two or more external systems at different times, for example the systems shown in FIGS. 14A-B, 15A-C, 16, 21A-B, and 22A-C. The connecting hardware and/or tubing for each system may be customized in order to interface with the universal port, and the user of a port which is interchangeable among treatment and/or therapy systems mitigates or prevents the need to provide a negative pressure sock with a large number of different ports, thereby minimizing complexity and manufacturing cost, according to embodiments of the present invention.

As used herein, the term “negative pressure” is used to refer to a pressure which is lower than the pressure outside of the sock, and also refers to a vacuum or near-vacuum condition in which most or all of the air has been evacuated from a chamber, and a suction force applied to the chamber, according to embodiments of the present invention.

Various modifications and additions can be made to the exemplary embodiments discussed without departing from the scope of the present invention. For example, while the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What is claimed is:

1. A device for administering negative pressure to a subject, comprising:
a sock formed at least partially of a flexible air impermeable layer, the sock configured to receive a limb of the subject;
one or more sealing elements configured to form one or more substantially air tight chambers, the one or more substantially air tight chambers formed at least partially by the flexible air impermeable layer;
a pump that is pneumatically coupled to each of the one or more substantially air tight chambers; and
a controller configured to operate the pump to selectively evacuate air from, and lower a pressure level in, at least one of the one or more substantially air tight chambers, wherein the controller is configured to operate the pump at a substantially constant rate.

2. The device of claim 1, wherein the one or more substantially air tight chambers is also formed at least partially by the limb of the subject.

3. The device of claim 1, wherein the controller includes an adjustable step-up/step down switching DC-DC converter.

4. The device of claim 3, wherein the adjustable step-up/step down switching DC-DC converter is configured to provide an adjustable, constant voltage supply.

5. The device of claim 1, wherein the controller comprises a micro controller and a plurality of electrical pneumatic switches that are each coupled to one of the one or more substantially air tight chambers.

6. The device of claim 5, wherein the controller is coupled to an adjustable step-up/step-down switching DC-DC converter that is configured to provide an adjustable constant voltage supply.

7. The device of claim 5, wherein the micro controller is configured to actuate the plurality of electrical pneumatic switches at predetermined times.

8. The device of claim 1, further comprising an air channel that is ultrasonically welded to the sock, and wherein the air channel comprises a port and a spiral wrap or spring encased in the air channel.

9. The device of claim 8, wherein the air channel is pneumatically coupled to each of the one or more substantially air tight chambers, wherein the air channel comprises a check valve for each of the one or more substantially air tight chambers coupled to the air channel, and wherein the check valves are placed in series and are configured to open at different air pressures to create a pressure gradient across the one or more substantially air tight chambers.

10. The device of claim 1, further comprising at least one port, wherein the at least one port includes a seal, wherein the at least one port is configured to receive a patient treatment system in fluid communication with one of the one or more substantially air tight chambers, and wherein the seal is configured to maintain a negative pressure within the one of the one or more substantially air tight chambers during connection of the patient treatment system to the at least one port.

11. The device of claim 10, wherein the patient treatment system comprises a tube coupled to a patient treatment pump, a patient treatment controller, and a reservoir, wherein the patient treatment controller is configured to selectively operate the patient treatment pump to convey matter between the reservoir and an interior of the sock through the at least one port.

12. The device of claim 10, wherein the at least one port comprises a plurality of ports, and wherein each of the plurality of ports is located on one of the one or more substantially air tight chambers.

13. The device of claim 10, wherein the at least one port is located above a wound.

14. The device of claim 1, wherein the one or more substantially air tight chambers comprise an inner chamber and an outer chamber, and wherein the controller is configured to maintain an air pressure in the inner chamber at a different level than an air pressure in the outer chamber.

15. The device of claim 1, wherein the one or more substantially air tight chambers are wrapped around the sock.

16. The device of claim 1, further comprising an inner layer including a plurality of air impermeable bands, wherein the one or more substantially air tight chambers are partially formed by a plurality of disk seals that are attached to an inner surface of the flexible air impermeable layer and that are configured to engage with the air impermeable bands of the inner layer.

17. A method for administering negative pressure to a subject, comprising:
placing a sock on a limb of a subject, the sock formed at least partially of a flexible air impermeable layer, wherein the flexible air impermeable layer includes one or more sealing elements configured to form one or more substantially air tight chambers between the flexible air impermeable layer and the subject; and
using a pump pneumatically coupled to each of the one or more substantially air tight chambers to selectively evacuate and draw a negative pressure in at least one of the one or more substantially air tight chambers.

18. The method of claim 17, wherein selectively evacuating and drawing the negative pressure in at least one of the one or more substantially air tight chambers includes:
applying a vacuum to a first air tight chamber of the one or more substantially air tight chambers during a first period of time; and
applying a vacuum to a second air tight chamber of the one or more substantially air tight chambers, while removing the vacuum on the first air tight chamber during a second period of time.

19. The method of claim 18, further comprising applying a vacuum to a third air tight chamber of the one or more substantially air tight chambers, while removing the vacuum on the second air tight chamber and the first air tight chamber during a third period of time.

20. The method of claim 17, wherein the one or more substantially air tight chambers includes an inner chamber and an outer chamber, and wherein selectively evacuating and drawing the negative pressure in at least one of the one or more substantially air tight chambers includes:
changing an air pressure in the inner chamber to a first pressure level and changing an air pressure in the outer chamber to a second pressure level,
wherein the first pressure level is different from the second pressure level.

21. The method of claim 20, wherein changing the air pressure in the inner chamber includes removing air from the inner chamber and wherein changing the air pressure in the outer chamber includes adding air to the outer chamber.

22. The method of claim 17, further comprising changing a pressure in each of the one or more sealing elements.

23. The method of claim 17, wherein the one or more of the substantially air tight chambers are wrapped around the flexible impermeable layer, and wherein changing the pressure in at least one of the one or more substantially air tight chambers includes changing a pressure in portions of the one or more substantially air tight chambers located at a distal end of the flexible air impermeable layer to be greater than a pressure in portions of the one or more substantially air tight chambers located at a proximal end of the flexible air impermeable layer.

24. The method of claim 17, further comprising attaching a port to the flexible impermeable layer.

25. The method of claim 24, wherein attaching the port comprises cutting a hole in the flexible impermeable layer.
